(19) United States
(12) Patent Application Publication
(10) Pub. No.: US 2004/0062849 A1
(43) Pub. Date: Apr. 1, 2004

(54) Infant formula containing partially hydrolyzed isolated soy protein with a reduced phytate content

(75) Inventors: Eric L. Lien, Malvern, PA (US); Charles F. Kuhlman, Media, PA (US)

Correspondence Address: WYETH, PATENT LAW GROUP, FIVE GIRALDA FARMS, MADISON, NJ, 07940, US

(73) Assignee: Wyeth, Madison, NJ

(21) Appl. No.: 10/663,923

(22) Filed: Sep. 16, 2003

Related U.S. Application Data
(60) Provisional application No. 60/411,280, filed on Sep. 17, 2002.

(51) Int. Cl. A23L 1/36

(52) U.S. Cl. 426/629

(57) ABSTRACT

Nutritional formulas are provided which comprise isolated soy protein wherein the isolated soy protein has a phytate content of 100 mg per liter or less; and the isolated soy protein has a degree of hydrolysis between 5 and 20%.

### FIELD OF THE INVENTION

The present invention relates to infant formula compositions comprising isolated soy protein and methods of feeding infants with such a formula.

### BACKGROUND OF INVENTION

Soy-based infant formulas are lactose-free, vegetarian alternatives to milk-based infant formulas for infants. Soy-based infant formulas may also be fed to infants with intolerance to cow milk-based feedings.

Infant formulas represent the sole item of diet of many infants for the first months of life. This total nutritional dependency has stimulated efforts to improve the nutritional quality of soy-based infant formula products.

Early soy-based infant formulas were based on full-fat soy flour. However, it was found that the indigestible soy oligosaccharides raffinose and stachyose in soy flour led to excessive intestinal gas. In 1965, the first infant formula based on soy protein isolate, more accurately described as isolated soy protein, was introduced in the United States. Current soy-based infant formula products contain isolated soy protein (“ISP”) supplemented with the essential amino acid L-methionine as the protein source (see, eg, “Nutrition of Normal Infants,” edited by Fomon, p. 428, 1993).

ISP is defined as the major proteinaceous fraction of soybean prepared from high quality, sound, cleaned, dehulled soybeans by removing a preponderance of the non-protein components. Generally, ISP contains not less than 90% protein on a moisture-free and ash-free basis, (Wilcke et al., eds., “Soy Protein and Human Nutrition”, New York, N.Y.: Academic Press Inc., pages 19-51, 1979). Harvested soybeans are processed to remove the hull. The oil in the crushed beans is then removed by solvent extraction to produce defatted flakes. Soy protein isolate is extracted from the defatted flakes in a slightly alkaline solution, separated from the insoluble polysaccharides and crude fiber by centrifugation, and then precipitated by acidification to approximately pH 4.5 to effect separation from the soluble soy oligosaccharides.

ISP possesses some nutritionally disadvantageous characteristics. One disadvantageous characteristic of ISP is its phytate content. Phytate is defined nutritionally as the higher phosphate esters of inositol. Soybeans contain nutritionally significant amounts of phytate. The phytate in soy is normally retained in ISP during manufacture thereof. Typical commercial ISP contains approximately 1.5% phytate (Maga, “Phytate: Its Chemistry, Occurrence, Food Interactions, Nutritional Significance, and Methods of Analysis,” J. Agric. Food Chem., 30:1-9, 1982).

Thirty percent of the essential mineral phosphorus in typical ISP is present as phytate. Phytate is a poorly biologically available source of phosphorus. Accordingly, ISP-based infant formulas contain levels of total phosphorus approximately 20% higher than milk-based infant formulas because milk-based infant formulas contain no phytate and thus no phytate-phosphorus.

Phytate creates an additional nutritional disadvantage for soy-based infant formulas because phytate binds minerals, especially calcium and zinc, and reduces their biological availability. “Soy Protein-Based Formulas: Recommendations For Use In Infant Feeding”, Pediatrics, 1998; 101:148-153) indicates that the percentage of absorption of zinc from soy-based formula (14%) is about one-third of the percentage of absorption of zinc from breast milk (41%). As a consequence, ISP-based infant formulas are fortified at a higher level of zinc than are milk-based infant formulas. Therefore, it is postulated that a reduction in the phytate content will increase the bioavailability of minerals in an infant formula.

Consequently, a variety of methods for reducing or eliminating phytate from soy flour and ISP have been developed. For example, Ford et al. J. Am. Oil Chemists Soc., 55:371-374, (1978) disclose a process of adjusting the pH and calcium concentration during precipitation of the protein from full-fat soy flour to eliminate up to 90% of the phytate. U.S. Pat. No. 6,284,502 discloses a process for converting phytate in a food into inorganic phosphate, said process comprising mixing a slurry of the phytate-containing food with phytase enzyme. U.S. Pat. No. 6,313,273 discloses a method comprising treating a soy protein source with one or more enzymes possessing nuclease and phytase activity, followed by ultrafiltration and diafiltration to remove phytic acid, isoflavones and nucleic acids, to produce a soy protein with reduced levels of phytate, isoflavones and nucleic acids. Phytate levels are reduced by at least 50% and more preferably by about 70%. U.S. Pat. No. 5,248,804 discloses a process for the removal of phytate from protein using ion exchange. These and other processes for reducing or eliminating the phytate in soy proteins are known to those skilled in the art.

The efficacy of infant formulas comprising ISP with reduced phytate content has been studied in primate infants. For example, Lonnerdal et al, Amer. J. Clin. Nutr., 1999,69(3):490-496 disclose that infant rhesus monkeys fed an infant formula made with a low-phytate ISP had greater zinc absorption and significantly lower plasma copper levels than infant monkeys fed a regular ISP-formula. However, they observed no difference in the weight gain of the infant monkeys fed these two formulas.

Soy protein can also be partially hydrolyzed to improve its utility for patients with compromised nutritional status. An increase in the degree of hydrolysis of the soy protein makes the soy protein more easily digestible. A variety of methods have been developed to hydrolyze soy protein. See, for example, U.S. Pat. No. 3,970,520 which discloses a method for treating isolate soy protein with proteolytic enzyme preparations to form soluble protein hydrolysates with molecular weights of 200 to 900 Daltons.

U.S. Pat. No. 4,100,024 discloses a method for producing soy hydrolysates with a reported degree of hydrolysis of 8% to 15%.

U.S. Pat. No. 4,443,540 discloses a method for preparing soluble, low molecular weight protein hydrolysates from soy protein isolate, by treating the protein material with proteolytic enzyme, followed by ultrafiltration to remove the protein hydrolysates in the permeate.

U.S. Pat. No. 6,126,973 discloses an enzymatic method to selectively hydrolyze the 7S globulin (beta-conglycinin) protein of soy. U.S. Pat. No. 6,303,178 discloses a polypeptide composition obtained by independently hydrolyzing the 7S component and the 11S component of soybean protein.

U.S. Pat. No. 6,221,423 discloses a composition produced by subjecting insoluble protein, preferably soy protein, to an enzyme preparation with substantial exopeptidase activity and substantial endopeptidase activity. The reported degrees of hydrolysis of the examples all exceed 10%.

Burks et al. “Prospective Oral Food Challenge Study of Two Soybean Protein Isolates In Patients With Possible Milk Or Soy Protein Enterocolitis”, Pediatr. Allergy Immunol., 5:40-45, (1994) and Burks et al. “Identification and Comparison of Differences In Antigens In Two Commercially Available Soybean Protein Isolates”, J. Food Science. 53(5):1456-1459, (1988) disclose that the ISP used to make powdered ISP-based infant formulas is a mildly hydrolyzed form of the ISP used to make liquid ISP-based infant formulas. The degree of hydrolysis of the typical commercial ISP used to make powdered ISP-based formulas is about 4% and the degree of hydrolysis of the typical commercial ISP used to make liquid ISP-based infant formulas is about 2%.

Soy-based infant formulas made with partially hydrolyzed ISP have been fed to full-term infants to identify if the formulas are superior to a standard ISP-based infant formula with respect to growth and development. Janas et al. “Tolerance of Soy Formulas With Reduced Phytate/Phytoestrogens Fed To Healthy, Term Infants”, Poster presented at the Second International Symposium On The Role of Soy In Preventing and Treating Chronic Disease, Brussels, Belgium, September 1996 describe an infant feeding study in which term human infants were fed a standard ISP-based infant formula or an infant formula based on partially hydrolyzed ISP for two weeks. The mean weight gains for both formula groups were similar over the 14-day study period, teaching that partially hydrolyzing soy isolate had no effect on the weight gained by human infants. Janas et al. disclose that the parents of the infants fed the hydrolyzed soy isolate formula indicated that their infants had watery and excessively frequent stools, an undesirable outcome.

### SUMMARY OF THE INVENTION

The present invention is directed to a nutritional formula for feeding human infants comprising isolated soy protein, wherein (a) the isolated soy protein has a phytate content of 100 mg per liter or less; and (b) the isolated soy protein has a degree of hydrolysis between 5 and 20%. The present invention is further directed to methods for feeding infants comprising administering the present formula to said infants.

### DETAILED DESCRIPTION OF THE INVENTION

The present invention is further directed to a nutritional formula comprising isolated soy protein where the isolated soy protein has a phytate content of about 100 mg per liter or less, preferably about 75 mg per liter or less and more preferably about 60 mg per liter or less. The ‘phytate content’ shall be understood to be equivalent to the inositol hexaphosphate content of the formula.

Furthermore, the nutritional formula of the present invention contains isolated soy protein that is partially hydrolyzed. Preferably, the present infant formula contains isolated soy protein having a degree of hydrolysis between about 5 to about 20%, preferably between about 5 to about 19%, more preferably about 5 to about 15% and most preferably between about 5 to about 10%.

Isolated soy protein or “ISP,” refers to a composition which contains, on a moisture-free and ash-free weight basis, at least 90% soy protein as measured using the Microkjeldahl method for determining nitrogen (AOAC (1975) “Official Methods of Analysis”, Section 47.021 Association of Official Analytical Chemists, Washington D.C.). The protein content is calculated from the nitrogen content using the conversion factor of 6.25.

Inositol hexaphosphate commonly abbreviated as “IP6” is the hexaphosphate ester of inositol (also known as phytic acid). The quantities of the phosphate esters of inositol are preferably measured by the HPLC method described in J. Food Science, 51(3):547-550 (1986). The HPLC method enables separation and quantitative determination of inositol triphosphate, inositol tetraphosphate, inositol pentaphosphate and inositol hexaphosphate in foods. The HPLC method can be used to obtain the inositol phosphate profile for products where phytate has been completely or partially hydrolyzed by either non-enzymatic or enzymatic means.

The degree of hydrolysis (commonly expressed as “% DH”) refers to the ratio of the number of peptide bonds cleaved to the total number of peptide bonds originally in the protein chain. Quantitative determination of the cleaved peptide bonds can employ the reaction of trinitrobenzenesulfonic acid, hereinafter referred to as “TNBS,” with primary amines to produce a chromophore that absorbs light at 420 nm. The intensity of color developed in the TNBS-amine reaction is proportional to the number of amino terminal groups created by the hydrolysis of peptide bonds in the protein. The total number of peptide bonds originally in the protein is calculated on a theoretical basis from the amino acid composition of said protein. The total number of peptide bonds in ISP is 885 per 100 kg.

The % DH may be calculated as follows:

% DH=(Peptide Bonds Cleaved)/(Total Peptide Bonds)×100,

and practically as follows:

% DH=[(S−B)/885]×100,

where “S” equals the number of moles of primary amine detected with TNBS in 100 kg of hydrolyzed ISP and “B” equals the number of moles of primary amine detected with TNBS in 100 kg of unhydrolyzed ISP, both “S” and “B” being expressed on a 100% protein basis calculated using the conversion factor of 6.25. If the value “B” is not analytically determined, a value of 24 can be used as the average number of moles of primary amine in 100 kg of unhydrolyzed ISP.

The present formulas may be in a liquid form, either as a ready-to-feed liquid or as a concentrated liquid requiring dilution with additional water before feeding, or in a powdered form requiring addition with water prior to use. The present infant formulas may be prepared by combining the isolated soy protein, one or more fats or oils, one or more sources of carbohydrate, amino acids, vitamins, minerals, and other nutrients and other substances known to those skilled in the art. See the Codex Standard for Infant Formula, CODEX STAN 72-1981 (amended 1983,1985, 1987), which is hereby incorporated by reference. The infant formulas of the present invention may contain one or more other ingredients known in the art to be useful in such nutritional formulations including but not limited to longer chain polyunsaturated fatty acids (U.S. Pat. No. 4,670,285, to Clandinin et al), ribonucleotides (U.S. Pat. No. 5,700,590, to Masor et al.), and oligosaccharides (U.S. Pat. No. 5,849,324, to Dohnalek).

The present invention is further directed to a method of feeding an infant, comprising feeding the infant a nutritionally sufficient amount of a nutritional formula comprising isolated soy protein wherein:

(a) the isolated soy protein has a phytate content of about 100 mg per liter or less; and

(b) the isolated soy protein has a degree of hydrolysis between about 5 and about 20%.

The nutritional formulas useful in this method preferably comprise isolated soy protein having a phytate content of about 75 mg per liter or less and more preferably about 60 mg per liter or less

Furthermore, the nutritional formula useful in the present method preferably contains isolated soy protein having a degree of hydrolysis between about 5 to about 19%, more preferably about 5 to about 15% and most preferably about 5 to about 10%.

### EXAMPLE 1

Two isolated soy proteins were obtained from Protein Technologies International (St. Louis, Mo.). Sample 1(a) was a low-phytate experimental isolated soy protein hydrolyzed to a DH of 6.3. A control formula, designated as Sample 1 (b) was an isolated soy protein with no modification of phytate content and a DH of less than 5%. Table 1 describes the compositional differences in these two isolated soy proteins.

| | 1(a) | 1(b) |
|---|---|---|
| Inositol hexaphosphate, (% by | 0.26 | 1.3-1.5 |
| weight of ISP) | | |
| Degree of Hydrolysis, % | 6.3 | 3.25 |

### EXAMPLE 2

An experimental infant formula was formulated with the isolated soy protein Sample 1 (a) which contained 60 mg of IP6 per liter when reconstituted for consumption. A control infant formula was formulated with the isolated soy protein Sample 1 (b) which contained 300 mg of IP6 per liter when reconstituted for consumption. Both infant formulas were supplemented with the L form of the essential amino acid methionine, as known to those skilled in the art. Both infant formulas contained the same fat blend of randomized palm olein, high oleic safflower oil, coconut oil and soybean oil, said fat blend providing 5.8 grams of linoleic acid per liter of reconstituted formula. Both infant formulas contained maltodextrin as the sole added carbohydrate source.

The control and experimental infant formulas were supplied in powder form which provided 670 kcal (2084 kJ) and the following nutrients per liter, when reconstituted according to label directions.

| | | Formula | Formula |
|---|---|---|---|
| | | (1(a)) | (1(b)) |
| Protein | g | 18 | 18 |
| Phytic acid (IP6) | mg | 60 | 300 |
| Fat | g | 36 | 36 |
| Carbohydrate (maltodextrin) | 9 | 69 | 69 |
| Vitamin A | IU | 2500 | 2500 |
| Vitamin D | IU | 425 | 425 |
| Vitamin E | IU | 11 | 11 |
| Vitamin K | mcg | 100 | 100 |
| Vitamin B1 (thiamin) | mcg | 1000 | 1000 |
| Vitamin B2 (riboflavin) | mcg | 1500 | 1500 |
| Vitamin B6 (pyridoxine) | mcg | 600 | 600 |
| Vitamin B12 (cyanocobalamin) | mcg | 2.0 | 2.0 |
| Niacin | mcg | 6000 | 6000 |
| Folic Acid | mcg | 80 | 80 |
| Pantothenic Acid | mcg | 3000 | 3000 |
| Biotin | mcg | 35 | 35 |
| Vitamin C (ascorbic acid) | mg | 90 | 90 |
| Choline | mg | 85 | 85 |
| Inositol | mg | 100 | 100 |
| Taurine | mg | 40 | 40 |
| L-carnitine | mg | 10 | 10 |
| Calcium | mg | 670 | 670 |
| Phosphorus | mg | 500 | 500 |
| Magnesium | mg | 67 | 67 |
| Iron | mg | 8.0 | 8.0 |
| Zinc | mg | 6.0 | 6.0 |
| Manganese | mcg | 200 | 200 |
| Copper | mcg | 500 | 500 |
| Iodine | mcg | 150 | 150 |
| Sodium | mg | 190 | 190 |
| Potassium | mg | 720 | 720 |
| Chloride | mg | 433 | 433 |

### EXAMPLE 3

The nutritional adequacy of the experimental formula (1a) was evaluated by assessing growth as well as mineral, trace element, and protein status in term infants. Growth indices were body weight, body length, and head circumference. Mineral and trace element status was gauged by measurements of serum calcium (Ca), magnesium (Mg), phosphorous (P), zinc (Zn), and copper (Cu).

The acceptability and tolerance of study formula were assessed on a continuous basis. Serum markers of protein status—albumin (Alb), blood urea nitrogen (BUN), and creatinine (Creat)—were measured at the beginning and at the end of the 12-week feeding period.

Healthy, term infants were randomized in a double-blind manner to receive either the experimental formula (1a) or the control formula (1b). At enrollment, infants were between 5 and 42 days of age. Their weights and lengths were between the tenth and ninetieth percentiles for age. Infants had to be exclusively formula fed, and able to tolerate soy-based infant formula for five or more days before enrollment. Written informed consent of the infant's parent or guardian was required. Ninety-one infants received the experimental formula 1 (a) and 89 received the control formula (1 b).

Within the three days before enrollment each infant received a physical examination which included measurement of weight, length, and head circumference. Blood was drawn and serum was analyzed by a central laboratory for Alb, BUN, Creat, Ca, Mg, P, Zn, and Cu.

At the baseline visit, a medical history was taken. Feeding of study formula began on the day of the baseline visit. The infants were fed ad libitum throughout the study. Fifty-five infants (60.4%) fed the experimental formula 1 (a) and 48 infants (53.9%) fed control formula (1b) were male, and 36 infants (39.6%) fed the experimental formula (1a) and 41 infants (46.1%) fed control formula (1b) were female. A total of 129 infants (71.7%) in the study were white, and 39 (21.7%) were black. The percentages of white and black infants were similar between the two feeding groups.

At Weeks 4, 8, and 12, each infant received a physical examination which again included measurement of weight, length, and head circumference. At Week 12, blood was drawn and serum was again analyzed for Alb, BUN, Creat, Ca, Mg, P, Zn, and Cu.

Results

At birth, the infants in the experimental group were slightly older and slightly larger, on average, than the infants in the control group. The mean gestational age at birth was 39.5 weeks for infants fed the experimental formula and 39.4 weeks for infants fed control formula. The mean birth weights were 3481.7 g for infants fed experimental formula and 3402.8 g for infants fed control formula; mean birth lengths were 51.1 cm and 50.2 cm, respectively; and mean head circumferences at birth were 34.7 cm and 34.5 cm, respectively. None of these differences between the study groups were clinically significant at baseline.

At baseline, the infants in the experimental group were approximately two days older, on average, than were infants in the control group (24.2 vs. 22.5 days). The mean weight for the experimental group was statistically significantly greater than that of the control group (4068.4 g versus 3894.8 g; p<0.05). The mean head circumference was also statistically significantly greater for the experimental group than the control group (36.9 cm versus 36.4 cm; p<0.03). There was no statistically significant difference in mean length at baseline.

At Weeks 4, 8, and 12, the infants in the experimental group were statistically significantly heavier, on average, than the infants in the control group, even after adjusting for gender and for the baseline differences between the two groups. At Week 4, the mean weight for the experimental group was 5018.8 g compared with 4599.9 g for the control group (p=0.0001); at Week 8, the mean weights were 5870.8 g and 5386.5 g, respectively (p=0.0002); and at Week 12, the mean weights were 6610.1 g and 6049.7 g, respectively (p=0.0001).

The rates of change in weight were consistent within the treatment groups over the course of the study and greater for the infants fed experimental formula at each point measured. For the experimental group, the change in weight from baseline to Week 4 was 8.2 g/kg/day; the change from baseline to Week 8 was 8.1 g/kg/day, and the change from baseline to Week 12 was 7.5 g/kg/day. For the control group, the change in weight from baseline to Week 4 was 6.7 g/kg/day, the change from baseline to Week 8 was 7.0 g/kg/day, and the change from baseline to Week 12 was 6.8 g/kg/day.

The mean weight change from baseline was higher for the infants fed experimental formula at each point measured. The difference in the rate of growth was greatest during the first four weeks and smallest in the last four weeks. The difference between the groups in mean weight change was 1.5 g/kg/day from baseline to Week 4, 1.1 g/kg/day from baseline to Week 8, and 0.7 g/kg/day from baseline to Week 12.

The infants in the experimental group were statistically significantly longer, on average, than the infants in the control group at Weeks 4, 8, and 12, even after adjusting for gender and the baseline differences between groups. The mean length of the infants at Week 4 was 57.0 cm for the experimental group and 55.8 cm for the control group (p<0.001); the mean lengths at Week 8 were 60.1 cm and 59.0 cm, respectively (P<0.005); and at Week 12 the mean lengths were 62.6 cm and 61.3 cm, respectively (P<0.0025).

At Week 4, the infants in the experimental group had statistically significantly larger head circumference, on average, than infants in the control group, even after adjusting for gender and the baseline differences between groups (38.9 cm versus 38.2 cm; p<0.005). Later measurements were inconsistent across the 21 clinical centers involved in the study.

Review of weight-to-length ratios of the infants indicated that both groups experienced normal growth during the study.

The mineral and trace element measurements were within the normal ranges for all of the variables measured at both baseline and Week 12. No clinically significant differences were noted between the two study groups at the two sampling times.

In summary, the results indicate that both formulas support normal growth but that the experimental formula surprisingly and unexpectedly is more effective than the control formula in supporting growth of the human infant.

The present invention may be embodied in other specific forms without departing from the spirit and essential attributes thereof and accordingly, reference should be made to the appended claims, rather than to the foregoing specification, as indicating the scope of the invention.

What is claimed is:

1. A nutritional formula for feeding human infants comprising isolated soy protein wherein: (a) said isolated soy protein has a phytate content of 100 mg per liter or less; and (b) said isolated soy protein has a degree of hydrolysis between 5 and 20%.

2. The formula of claim 1, wherein said isolated soy protein has a phytate content of 75 mg per liter or less.

3. The formula of claim 2, wherein said isolated soy protein has a phytate content of 60 mg per liter or less.

4. The formula of claim 1 wherein said isolated soy protein has a degree of hydrolysis between 5 to 19%.

5. The formula of claim 1, wherein said isolated soy protein has a degree of hydrolysis of between 5 to 15%.

6. The formula of claim 5, wherein said isolated soy protein has a degree of hydrolysis of between 5 to 10%.

7. A method of feeding a human infant, comprising administering to said human infant a nutritionally sufficient amount of an infant formula comprising isolated soy protein wherein (a) said isolated soy protein has a phytate content of 100 mg per liter or less; and (b) said isolated soy protein has a degree of hydrolysis between 5 and 20%.

8. The method of claim 7, wherein said isolated soy protein has a phytate content of 75 mg per liter or less.

9. The method of claim 8, wherein said isolated protein has a phytate content of 60 mg per liter or less.

10. The method of claim 7, wherein said isolated soy protein has a degree of hydrolysis of between 5 to 19%

11. The method of claim 10, wherein said isolated soy protein has a degree of hydrolysis between 5 to 15%.

12. The method of claim 11, wherein said isolated soy protein has a degree of hydrolysis between 5 to 10%.

13. Use of isolated soy protein for the manufacture of a medicament for the treatment of human infants with intolerance to cow milk-based feedings, the medicament being in the form of an infant formula for feeding said infants, wherein (a) said isolated soy protein has a phytate content of 100 mg or less per liter; and (b) said isolated soy protein has a degree of hydrolysis between 5 and 20%.

14. A composition for use as a pharmaceutical, said composition being in the form of an infant formula for feeding human infants, said infant formula containing isolated soy protein, wherein (a) said isolated soy protein has a phytate content of 100 mg or less per liter; and (b) said isolated soy protein has a degree of hydrolysis between 5 and 20%.

15. Use of an infant formula containing isolated soy protein for feeding infants without intolerance to cow milk-based feedings, wherein (a) said isolated soy protein has a phytate content of 100 mg or less per liter; and (b) said isolated soy protein has a degree of hydrolysis between 5 and 20%.
